(19) United States
(12) Patent Application Publication
(10) Pub. No.: US 2006/0213873 A1
(43) Pub. Date: Sep. 28, 2006

(54) ARC chute assembly and electric power switch incorporating same

(75) Inventor: John J. Shea, Pittsburgh, PA (US)

Correspondence Address: MARTIN J. MORAN, ESQ;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/088,031

(22) Filed: Mar. 23, 2005

(51) Int. Cl. H01H 9/44

(52) U.S. Cl. 218/34

(57) ABSTRACT

As many as possible of the arc plates of an arc chute assembly have complimentary reverse compound curves to form between them gas flow paths for arc gas that discharge directly into a gas vent. Where the gas vent is not large enough, the remaining arc plates have a concave upward curvature forming additional gas flow paths that discharge smoothly into a vertical gas passage adjacent their trailing edges that extends upward to the gas vent.

### BACKGROUND OF THE INVENTION

1. Field of the Invention

This invention relates to apparatus for extinguishing arcs in electric power switches, and more specifically, to an arc chute assembly that more efficiently exhausts gases generated by arcing during opening of the switch under load.

2. Background Information

When electric power switches, such as molded case circuit breakers, are opened under load an arc is struck across the separating contacts. This arc must be extinguished in order to interrupt the current in the power circuit. It is particularly critical to extinguish the arc generated during opening of a circuit breaker in response to a short circuit as early as possible in order to limit the current and thereby improve the interruption capability of the circuit breaker.

Effective current limiting in molded case circuit breakers requires fast and efficient cooling of the arc. Historically, arc chute plates, typically made from steel, have been flat plates stacked with an air gap between the plates. This basic geometry has been optimized over the years for the number of plates, plate spacing, and a variety of throat shapes. The stack of metal plates increases the arc voltage in an air circuit breaker to produce a current-limiting effect, thereby providing downstream protection. The increased arc voltage results from cooling the arc and splitting the arc into series arcs. Cooling, in turn, results from arc attachment to the metal plates, vaporization of the plates, and vaporization of insulating materials (intentionally from gassing materials) and expelling hot gases out of a vent. Arc splitting into series arcs also results in increased arc voltage due to additional cathode fall potential. Magnetic materials, such as steel, are used for arc plates for their ability to attract the arc due to the self-induced magnetic field produced from the fault current. In addition, arc cooling depends on the gas flow over the plates (convection) and hot gas removal out of the vent of the circuit breaker.

Many circuit breakers, especially molded case circuit breakers due to their small size and cable location adjacent to the arc chute, limit effective gas flow out of the breaker. By constricting gas flow and producing reflected shock waves in the arc chamber, the current limiting effectiveness is significantly reduced. This results in longer conduction times and even re-ignition of the arc after current zero, and can lead to case rupture due to excessive pressure.

There is a need, therefore, for an improved arc chute assembly and circuit breaker incorporating the same that more efficiently vents the arc gas generated during current interruption.

### SUMMARY OF THE INVENTION

This need and others are satisfied by the invention which is directed to facilitating the exhaustion of arc gas generated during opening of an electric power switch and to such a switch with the improved capability.

Aspects of the invention include an arc chute assembly structured for installation in an electric power switch between the separable contacts and a gas vent that is spaced in a first direction and a second direction perpendicular to the first direction from the separable contacts in their closed position within the switch casing. In a typical orientation of the electric power switch, such as a circuit breaker positioned on a horizontal surface with the operating handle on top, the first direction would be the horizontal and the second direction would be the vertical. In the assembly, a plurality of arc plates are supported by a support structure in spaced relation between the separable contacts and the gas vent with leading edges facing the separable contacts and trailing edges facing the gas vent. At least two adjacent ones of the arc plates have complementary reverse compound curvatures that establish between them a flow path for arc gas generated at separation of the separable contacts. This gas flow path is aligned with and discharges directly into the gas vent. The reverse compound curvature comprises a first curvature extending away from the leading edge in the first direction and toward the gas vent in the second direction and a second curvature extending away from the trailing edge in the first direction and toward the closed position of the separable contacts in the second direction.

According to one embodiment of the invention, each of the plurality of arc plates has a reverse compound curvature complementary to that of adjacent arc plates forming between them gas flow paths that discharge directly into the gas vent.

In another embodiment of the invention where not all of the gas flow paths can discharge directly into the gas vent, a selected number of the arc plates have reverse compound curvatures complementary to adjacent ones of the selected number of arc plates to form multiple gas flow paths that align with and discharge directly into the gas vent. In accordance with an additional aspects of this embodiment of the invention, the casing of the electric power switch defines a gas passage that extends generally in the second direction adjacent the trailing edges of the arc plates toward the gas vent. Others of the arc plates form between them additional gas flow paths that discharge into this gas passage. In this embodiment, the others of the arc plates have a concave curvature in the second direction toward the gas vent with the trailing edges displaced in the second direction toward the gas vent relative to the leading edges.

The invention also embraces an electric power switch incorporating arc chute assembly in these various embodiments.

### BRIEF DESCRIPTION OF THE DRAWINGS

A full understanding of the invention can be gained from the following description of the preferred embodiments when read in conjunction with the accompanying drawings in which:

FIG. 1 is a vertical section through an electric power switch incorporating a first embodiment of the invention.

FIG. 2 is a bottom plan view of the cover of the electric power switch of FIG. 1.

FIG. 3 is a vertical section through an electric power switch incorporating a second embodiment of the invention.

### DESCRIPTION OF THE PREFERRED EMBODIMENTS

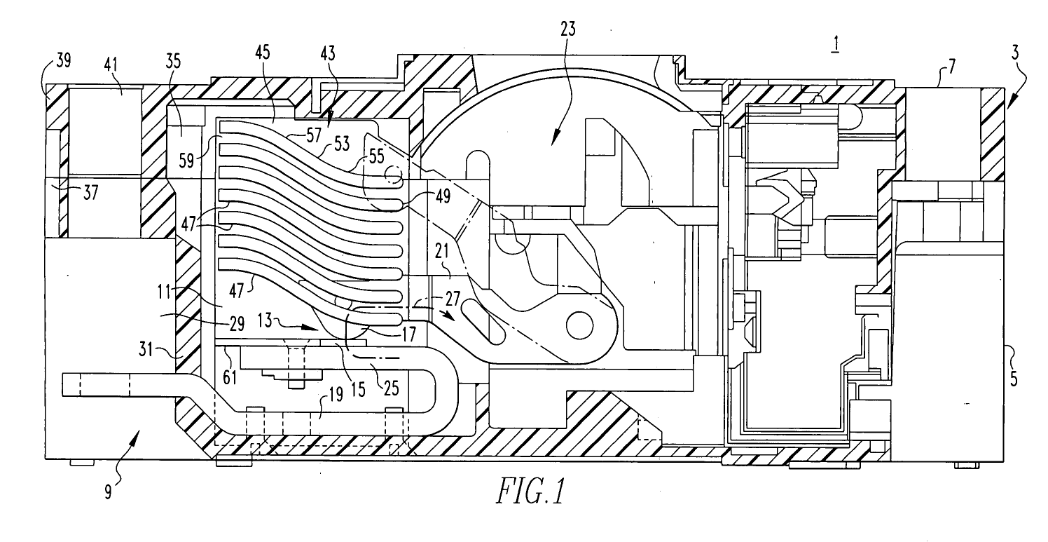

The invention will be described as applied to a molded case circuit breaker, however, it will be apparent that the invention has application to other types of electric power switches in which the contacts are separated in an ambient atmosphere. The molded case circuit breaker 1 has a casing 3 formed by a base 5 and a cover 7. The particular circuit breaker 1 is a three-pole breaker. Accordingly, the casing 3 has for each pole 9 an arc chamber 11 containing separable contacts 13 including a fixed contact 15 and a movable contact 17. The fixed contact 15 is mounted on a line side main conductor 19 while the movable contact 17 is mounted on the free end of a pivotally mounted contact arm 21. The contact arms 21 of all of the poles 9 are simultaneously rotated from a closed position in which the separable contacts 13 are closed as shown in FIG. 1 to an open position (shown in phantom) by an operating mechanism 23 in a well-known manner. The line side main conductor 19 is bent back upon itself at 25 so that current in this bent section 25 forms with the current flowing in the opposite direction through the movable contact arm 21 a reverse current loop 27 to generate magnetic repulsion forces that aid in rapid opening of the separable contacts 13 in response to high overcurrent, again as is well known.

The circuit breaker 1 has for each pole 9 an external terminal recess 29 that is separated from the corresponding arc chamber 11 by a vent wall 31 formed by the casing 3. The line side main conductor 19 extends from the fixed contact 15 through the vent wall 31 into the corresponding external terminal recess 29. A terminal assembly (not shown) in each terminal recess 29 connects the line side main conductor 19 of the pole 9 to an external conductor (also not shown).

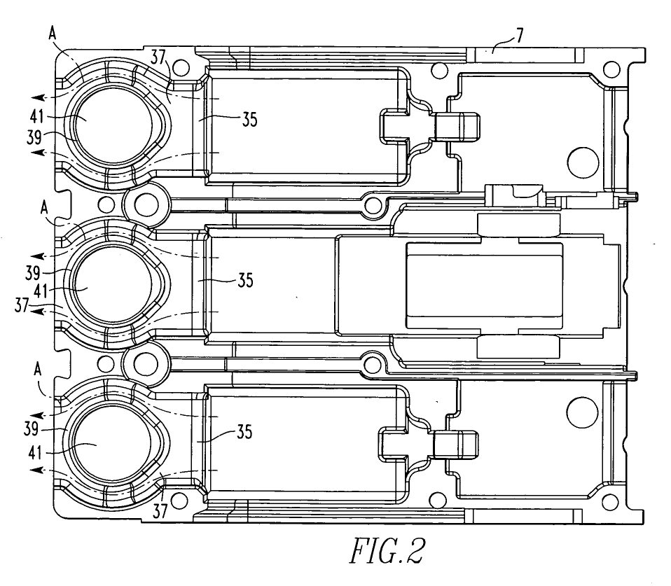

The vent wall 31 has a gas vent 35 in an upper portion above the terminal recess through which arc gas generated during opening of the separable contacts 13 is vented from the arc chamber 11. This gas vent 35 connects with the atmosphere through a passage 37 that extends around a protrusion 39 molded on the cover 7 that forms an opening 41 through which a tool can be inserted to manipulate a terminal assembly in the terminal recess 29. The arc gases escaping through the gas vent 35 flow through the passage 37 around this protrusion 39 as shown by the arrows A in the bottom plan view of the cover 7 shown in FIG. 2. In the embodiment of FIG. 1, the external terminal recess 29 extends only part way up the base 5 of the casing 3 so that the protrusion 39 and the passage 37 extend downward into the upper part of the base 5 making possible a longer gas vent 35.

Returning to FIG. 1, an arc chute assembly 43 is provided in the arc chamber 11 between the separable contacts 13 and the gas vent 37. The arc chute assembly 43 includes a supporting structure such as a molded housing or flat side plate 45 that supports a plurality of arc plates 47 in spaced relation. Each of the arc plates 47 has a leading edge 49 adjacent the separable contacts 13 and a trailing edge 51 facing the gas vent 35. Each of the arc plates 47 also has a reverse compound curvature 53. By reverse compound curvature 53 it is meant that each plate 47 has a first curvature 55 extending generally laterally away from the leading edge and upward and a second curvature 57 that extends generally laterally from the trailing edge and downward. In the exemplary embodiment, the second curvature leads directly into the first curvature so that there is a continuous but reversing curvature between the first curvature and the second curvature. Together the first and second curvatures form arc plates 47 that are concave upward adjacent the leading edge and convex upward adjacent the trailing edge.

Adjacent arc plates 47 with their reverse compound curvatures 53 form between them gas flow paths 59 that are generally aligned with and discharge directly into the gas vent 35. The reverse compound curvatures of adjacent arc plates 47 are complementary so that adjacent arc plates 47 are equally spaced from leading edge to trailing edge. This provides a smooth flow of gas to the gas vent 35. It is not necessary that the adjacent arc plates 47 be equally spaced throughout their lengths as long as there are no discontinuities including where the gas flow path discharges into the gas vent 35 so that the gas flow is laminar to enhance the escape of the gas and improve cooling of the arc. As is conventional, an arc runner 61 extending from adjacent the fixed contact 15 guides the arc into the arc plates 47.

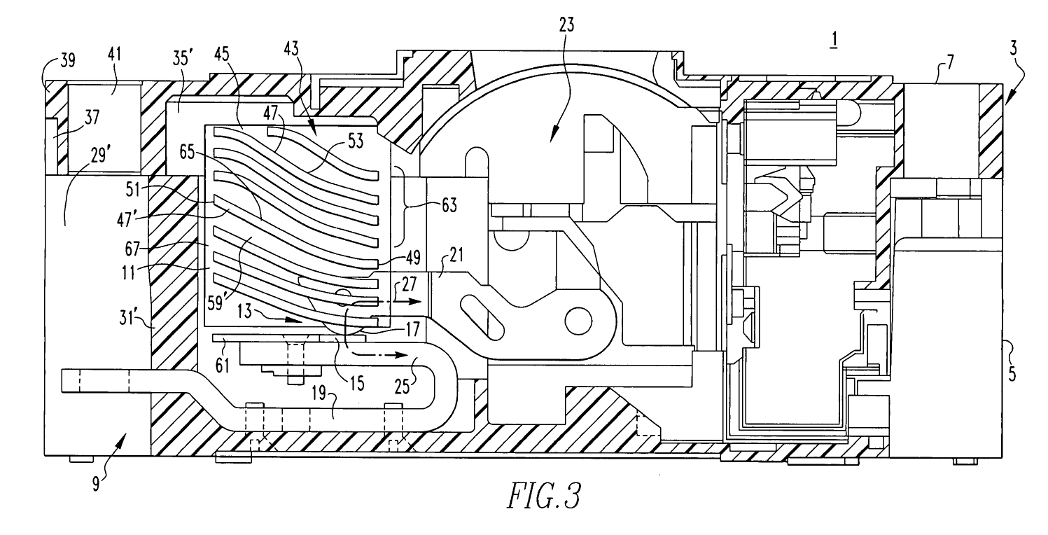

FIG. 3 illustrates another embodiment of the invention where the height of the gas vent 35′ is limited such as by the height of the external terminal recess 29′. In this case, a selected number 63 of the arc plates 47 at the top of the stack have the reverse compound curvature 53 that form the gas flow paths 59 that discharge directly into the gas vent 35′. The others of the arc plates 47′ below these arc plates 47 with the reverse compound curvature 53 have a single curvature 65 that makes them concave upward in the direction of the gas vent 35′ with their trailing edges 51 above their leading edges 49. These arc plates 47′ form additional gas flow paths 59′ that extend upward and discharge upward toward the gas vent 35′ into a vertical gas passage 67 between the vent wall 31′ and the trailing edges 51 of the arc plates 47′. As opposed to prior art arc chute assemblies in which the arc gases flowing between the lower arc plates discharge into such a gas passage with a large component perpendicular to the vent wall causing back pressure on the gases, the additional gas flow paths 59′ direct the gas smoothly into the gas passage 67 with negligible turbulence.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. An arc chute assembly structured to be positioned between separable contacts contained in a casing of an electric power switch and a gas vent in the casing spaced in a first direction and in a second direction perpendicular to the first direction from the separable contacts, the assembly comprising:
a plurality of spaced apart arc plates stacked in the second direction, each having a leading edge facing the separable contacts and a trailing edge facing the vent, at least two adjacent ones of the arc plates having complementary reverse compound curvatures that establish between them a flow path for arc gas generated at separation of the separable contacts that is aligned with and discharges directly into the gas vent; and
a support structure maintaining the spacing of the spaced apart arc plates.

2. The assembly of claim 1, wherein the at least two arc plates are spaced apart equally from the leading edge to the trailing edge.

3. The assembly of claim 1, wherein each arc plate has a reverse compound curvature complementary to adjacent arc plates forming gas flow paths that all discharge generally directly into the gas vent.

4. The assembly of claim 1, wherein the at least two arc plates are the two closest to the gas vent in the second direction.

5. The assembly of claim 1, wherein the complementary reverse compound curvatures each comprise a first curvature extending in the first direction away from the leading edge of the arc plate and in the second direction toward the gas vent, and a second curvature extending in the first direction away from the trailing edge of the arc plate and in the second direction toward the separable contacts when closed.

6. The assembly of claim 5, wherein the first curvature leads directly into the second curvature.

7. The assembly of claim 5, wherein the at least two of the arc plates comprise a selected number of arc plates having complementary reverse compound curvatures that form between them multiple gas flow paths that align with and discharge into the gas vent.

8. The assembly of claim 7, wherein the casing defines adjacent the trailing edges of the arc plates a gas passage leading in the second direction to the gas vent and others of the arc plates form between them additional gas flow paths that discharge into the gas passage.

9. The assembly of claim 8, wherein the others of the arc plates have a concave curvature toward the gas vent in the second direction with the trailing edge displaced further toward the gas vent in the second direction than the leading edge so that the additional gas flow paths direct arc gas into the gas passage in the second direction toward the gas vent.

10. An electric power switch comprising:
a pair of separable contacts movable between a closed position and an open position;
a casing containing the separable contacts and including a vent wall spaced in a first direction from the separable contacts and having a gas vent spaced in a second direction perpendicular to the first direction from the closed position of the separable contacts; and
an arc chute assembly positioned in the casing between the separable contacts and the gas vent wall and comprising:
a supporting structure positioned in the casing between the separable contacts and the vent wall; and
a plurality of arc plates supported in spaced apart relation by the supporting structure each having a leading edge facing the separable contacts and a trailing edge facing the gas vent, at least two adjacent ones of the arc plates having complementary reverse compound curvatures that establish between them a flow path for arc gas generated at separation of the separable contacts that is aligned with and discharges directly into the gas vent.

11. The electric power switch of claim 10, wherein each arc plate has a reverse compound curvature complementary to adjacent arc plates forming gas flow paths that all discharge directly into the gas vent.

12. The electric power switch of claim 10, wherein the reverse compound curvatures comprise a first curvature extending in the first direction away from the leading edge of the arc plate and in the second direction toward the gas vent and a second curvature extending in the first direction away from the trailing edge of the arc plate and in the second direction toward the separable contacts in the closed position.

13. The electric power switch of claim 10, wherein the first curvature leads directly into the second curvature.

14. The electric power switch of claim 12, wherein the at least two arc plates comprise a selected number of arc plates having complementary reverse compound curvatures that form between them multiple gas flow paths that all align with and discharge directly into the gas vent.

15. The electric power switch of claim 14, wherein the vent wall defines adjacent the trailing edges of the arc plates a gas passage leading in the second direction toward the gas vent and others of the arc plates form between them additional gas flow paths that discharge into the gas passage.

16. The electric power switch of claim 15, wherein the others of the arc plates have a concave curvature toward the gas vent in the second direction with the trailing edge displaced further toward the gas vent in the second direction than the leading edge so that the additional gas flow paths direct arc gas into the gas passage in the second direction toward the gas vent.

17. The assembly of claim 1, wherein said at least two adjacent ones of the arc plates having complementary reverse compound curvatures are concave upward adjacent the leading edge thereof and convex upward adjacent the trailing edge thereof.

18. The electric power switch of claim 10, wherein said at least two adjacent ones of the arc plates having complementary reverse compound curvatures are concave upward adjacent the leading edge thereof and convex upward adjacent the trailing edge thereof.
